(19) United States
(12) Patent Application Publication
(10) Pub. No.: US 2024/0168920 A1
(43) Pub. Date: May 23, 2024

(54) METHOD OF ASSESSING A LOG-FILE, METHOD OF GROUPING SEVERAL LOG-FILES, AND SYSTEM FOR PROCESSING AT LEAST ONE LOG-FILE

(71) Applicant: Rohde & Schwarz GmbH & Co. KG, Munich (DE)

(72) Inventors: Sebastian Engel, Munich (DE); Detlef Wiese, Munich (DE); Agustin Raez-Rus, Munich (DE); Fernando Garcia, Munich (DE); Andrew Schaefer, Munich (DE); Sandra Merkel, Munich (DE); Bernhard Sterzbach, Munich (DE); Jonas Baehr, Munich (DE); Julian Jorczik, Munich (DE)

(73) Assignee: Rohde & Schwarz GmbH & Co. KG, Munich (DE)

(21) Appl. No.: 18/058,524

(22) Filed: Nov. 23, 2022

(51) Int. Cl. G06F 16/16; G06F 16/17; G06F 16/174

(52) U.S. Cl. CPC G06F 16/16; G06F 16/1734; G06F 16/1744

(57) ABSTRACT

A method of assessing a log-file is described. A log-file to be assessed is received. A data storage is accessed that includes several log-files. A group of log-files from the several log-files stored in the data storage is identified. The group of log-files includes log-files that are nearest to the log-file to be assessed. The identified group of log-files is returned to a user for further analysis. Further, a method of grouping several log-files as well as a system for processing at least one log-file are described.

### FIELD OF THE DISCLOSURE

Embodiments of the present disclosure relate to a method of assessing a log-file. Further, embodiments of the present disclosure relate to a method of grouping several log-files. Embodiments of the present disclosure also relate to a system for processing at least one log-file.

### BACKGROUND

Test and measurement systems typically provide log-files that are used to provide additional information for a user or rather an operator of the test and measurement system with regard to a measurement performed by means of the test and measurement system.

In case of complex test and measurement systems which may comprise multiple devices involved in performing a certain measurement, a program may be executed on all or at least a part of these devices, wherein log protocols may be tracked when executing the program. The log protocols may have multiple formats, for instance a text-based format or any other electronically storable format. The log protocols obtained may be summarized for a certain problem to a log-file.

Typically, the log-files have small possible human comprehensible sizes as they might be very large such that the respective information encompassed cannot be understood by a human due to the amount of information contained. In other words, the log-files comprise human non-trackable information due to the amount of information encompassed. Accordingly, analysis techniques have been implemented in the state of the art, also called log-analyses, for analyzing the respective contents of the log-files. Possible targets of those analyses may relate to the identification of root causes of an unwanted behavior of the executed program, a deeper analysis of a single step of the executed program or an automatic initialization of processes related to extracted content like assigning a task force for reacting on a particular behavior of the executed program.

In the state of the art, the log-files are processed by predefined root-based approaches that allow for extraction/parsing of human understandable messages. Hence, these approaches require well-prepared rules that fit to the specific log-file format. However, those approaches may not be applicable anymore in many scenarios, as large execution programs, which are typically used in modern test and measurement systems, are programmed by multiple people and/or based on multiple external/internal software/hardware packages, also called sub-components. This can result in dynamically changing, uncontrollable log-files with regard to their format and/or content. Consequently, the well-prepared rules of the predefined root-based approaches are not applicable anymore.

Accordingly, there is a need for a general approach that allows for assessing a log-file irrespective of its format and/or its content.

### SUMMARY

Embodiments of the present disclosure provide a method of assessing a log-file.

The method comprises the steps of:
Receiving a log-file to be assessed,
Accessing a data storage that comprises several log-files,
Identifying a group of log-files from the several log-files stored in the data storage, wherein the group of log-files comprises log-files that are nearest to a log-file to be assessed, and
Returning the identified group of log-files to a user for further analysis.

Accordingly, the main idea is that a user obtains the identified group of log-files in order to get an overview over log-files that have similarities, similar issues, as the log-file to be assessed. Thus, the log-files comprised in the identified group of log-files relate to a collection of log-files from the several log-files stored in the data storage, which are most similar to the log-file to be assessed.

Accordingly, the method, e.g. steps performed by an analysis engine, outputs the identified group of log-files, namely the collection of similar cases found in the data storage, that fits to the given log-file, namely the log-file to be assessed, in a most appropriate manner.

Generally, the method may be carried out by an analysis engine, e.g. a software running on a processor circuit, namely hardware.

The respective method relates to a data-driven approach that does not require a human interaction to define any possibly not sufficient rules. Hence, the complex and dynamic environments mentioned before is tackled accordingly. In other words, the method allows to tackle dynamically changing log-file formats or contents. In this context, data-driven means that the analysis engine is generated with respect to the data associated with the log-files stored in the data storage. Provided that log-files for multiple program executions are reachable to the analysis engine, statistically driven analysis engines may be used, e.g. machine learning based approaches to obtain a data-based procedure that ideally allow for the results of the analysis engine to be inter/extrapolated by the underlying data used.

The data storage comprising the several log-files corresponds to a record storage, as the several log-files stored in the data storage relate to records. For instance, the several log-files have been recorded when performing a measurement on a device under test or rather testing a device under test by means of a test and measurement device.

The device under test may relate to a user equipment (UE), for instance a mobile (phone), a smartphone or a tablet.

The several log-files may be unlabeled. In other words, the group of log-files is identified without relying on a label of the log-files or rather labels of the log-files. Hence, unlabeled data is taken into account when identifying the similarities between the log-file to be assessed and the group of log-files which comprises the log-files that are nearest to the log-file to be assessed. In other words, the method relates to an unlabeled similarity identification, as it allows for using unlabeled data sets, namely the log-files, which can be considered for obtaining a first suggestion of similar log-files found in the data storage to be used by the user for own investigations.

An aspect provides that the log-files are returned that are comprised in the identified group of log-files. Therefore, the user may receive the individual log-files stored in the data storage that are most similar to the log-file to be assessed. Based on those log-files returned, the user may obtain information necessary to obtain information concerning the log-file to be assessed, for instance a deeper insight or rather hints.

Another aspect provides that the several log-files are grouped such that several different log-file groups are obtained that each comprise a plurality of log-files. According to an embodiment, the several log-files may already be stored in different groups depending on their respective similarities. Thus, the data storage already comprises the different log-file groups. Put differently, the several log-files may be pre-analyzed for similarities, e.g. based on a default grouping/clustering, in order to group the log-files into the different groups of log-files.

Alternatively, the several log-files are grouped/clustered when accessing the data storage, e.g. by means of a processing circuit that may also asses the log-file to be assessed. Hence, a grouping/clustering may take place while processing the several log-files. For instance, a certain category of grouping/clustering, e.g. a certain grouping/clustering algorithm, may be selected based on the log-file to be assessed. Hence, the log-file to be assessed may be pre-analyzed in order to select the certain category of grouping/clustering, e.g. the certain grouping/clustering algorithm, which is applied on the several log-files stored in the data storage so as to cluster/group those log-files.

Generally, the clustering/grouping allows to label the log-file groups in a group-wise manner which comprise the plurality of log-files rather than labelling each individual log-file in many single steps, thereby reducing the overall efforts and/or computational power necessary.

For instance, a cluster labelling is provided in order to additionally provide information based on the groups of log-files. The labeling concerns a post-labeling, as the log-files, particularly the log-file groups, are labeled subsequently, namely when accessing the data storage, for instance identifying the group of log-files that comprises the log-files that are nearest to the log-file to be assessed. Hence, only the identified group of log-files may be post-labeled.

The post-labeling may be done manually by the user or rather operator that assesses the identified group of log-files, particularly the individual log-files contained in the identified group of log-files.

In general, the cluster labelling ensures that new customers/users with an unprepared environment can be implemented to the analysis engine that is already equipped with analysis tools like the unlabeled similarity identification.

In other words, the identified group of log-files that comprise the log-files with similar patterns (related to the log-file to be assessed) can be used by the user for own investigations or for semi-automatic labeling. Hence, it is sufficient to have one log-file within the identified group of log-files that is labeled with a label, wherein the respective label is extended to the other log-files of the identified group of log-files as well as the log-file to be assessed.

Hence, further labeling of the several log-files stored in the data storage is not necessary, which can be of advantage if the several log-files have no or almost no labels.

In summary, similar log-files with regard to context, content and/or pattern found in the data storage can be presented to the user based on the log-file to be assessed.

According to another aspect, compressed representations of the several log-files as well as the log-file to be assessed are generated, wherein the group of log-files is identified based on the compressed representations. The identified group of log-files comprises the log-files that are nearest to the log-files to be assessed. The compressed representation may relate to a vector representation, e.g. a float-vector representation. Hence, the investigated log-file, namely the log-file to be assessed, is transformed into the compressed representation, for instance the vector representation, thereby encoding the content of the log-file in such a way that its content and/or context can be related to the several log-files stored in the data storage.

Generally, the several log-files may include text-based log-information, categorical-based log-information and/or numerical-based log-information. All these different kinds of log-information are taken into account for providing the compressed representation such that the required efforts can be reduced when identifying the group of log-files that comprise the log-files that are nearest to the log-file to be assessed.

Furthermore, the several log-files as well as the log-file to be assessed are compressed by at least one compression method in order to obtain the compressed representations, wherein the at least one compression method comprises at least one of a natural language processing based approach and/or a machine-learning based approach. Accordingly, compression methods may be applied for obtaining the compressed representation, for instance natural language processing and/or machine-learning based approaches.

When the several log-files stored in the data storage are accessed, the compressed representations may be obtained. In other words, compressed representations of the several log-files stored in the data storage are generated/learnt, particularly based on the compression methods.

The log-files may be grouped to log-file groups based on an underlying pattern associated with the log-files. The several log-files may be grouped by the analysis engine when accessing the data storage. Alternatively, the several log-files have been pre-analyzed, wherein a respective label for the log-files or rather the associated group of log-files has been determined, which can be accessed for further analysis.

For instance, the underlying pattern may relate to similarities in the compressed representations of the log-files. The similarities may correspond Euclidean distances in a space associated with the compressed representations, also called compressed space.

Hence, the log-files may be grouped to log-file groups based on an underlying pattern associated with the log-files, wherein the underlying pattern is derived from a compressed representation of the several log-files. As mentioned above, the compressed representations may relate to vector representations that have been obtained by using compression methods like natural language processing (NLP) based approaches and/or machine-learning based approaches.

Thus, the different log-files, particularly the log-files in different formats, are processed by means of the compression methods in order to obtain the compressed representations. The compressed representations of the log-files are further processed in order to identify underlying patterns within the compressed representations. Based on these underlying patterns identified for the respective log-files, the groups of log-files are determined, wherein log-files with similar underlying patterns are grouped together.

The log-files may be formatted differently. Since the method relates to a data-driven approach, different formats of the several log-files can be processed in order to assess the log-file to be assessed.

Moreover, information may be returned that is associated with the group identified. The respective information may relate to a label that was given to the respective group identified, for instance a label associated with an underlying pattern of the identified group, particularly an underlying pattern of the log-files encompassed in the group. In fact, the underlying pattern is the one based on which the clustering/grouping of the several log-files took place.

As indicated above, the label associated with the identified group may be obtained based on at least one label that was assigned previously to at least one of the log-files contained within the identified group. The other log-files may be post-labeled based on that already existing label, particularly the identified group.

The label(s) may also relate to tag(s) such as a verdict tag, for instance error, passed, inconclusive etc.

Based on the label(s)/tag(s), a data driven classification mapping may be generated which can be used to define a mapping that allows for identifying main contributors (sub-components) inside a log-file, leading to the related tag/label. This can be used to identify the main contributors (sub-components) of the log-file to be assessed that may cause a specific result. Such tag/label can help the user to focus on main specific parts of the log-file and thus possibly speed up the reaction, e.g. finding a root cause.

Accordingly, a possible cause identification report or a possible cause identification tag may be part of the information that is returned, wherein the possible cause identification report/tag allows for identification of result-related sub-components and more precise root causes.

In case of cause label(s)/tag(s), namely tag(s)/label(s) related to causes of an incident found inside a log-file, support entities can be identified which can be addressed for more professional investigations and thus for automatizing the process of assigning corresponding support teams automatically. The user can start the process after the feedback accordingly.

Generally, if the log-files are labeled by specific properties, e.g. a label of root cause of failure, a label associated with a solution to an underlying problem, a label associated with a process started for the status of the log-file. Most fitting labels to the log-file to be assessed may be suggested.

The suggested labels derived can be used by the user for own investigations, e.g. comparisons or investigations against a labeled root cause, using a labeled solution, and/or executing a labeled process.

The respective method can be enhanced by an explainer approach that is used to focus the attention of the user to the most contributing parts (sub-components of a log-file) which possibly helps to identify faster result causing events in the log-file to be assessed.

The several log-files may be at least partially labeled by labels. Hence, certain log-files may be already labelled, e.g. by means of existing labels. As indicated above, the label may be of different types.

The labelling may be done based on the compressed representations of the log-files.

In addition, a group-wise labelling may take place such that the different groups of log-files are labeled differently in order to distinguish the respective groups among each other. The respective labelling may relate to a label like “broken cable”.

As already discussed above, the labels may relate to analysis information. The analysis information may comprise action recommendations for the user, e.g. replace broken cable, get in contact with a responsible solution team and so on. Therefore, recommendations are given to the user when assessing the log-file to be assessed.

The several log-files may comprise labeled log-files and non-labeled log-files, wherein the non-labeled log-files are processed in order to automatically label the non-labeled log-files based on the labeled log-files. Since similarities of the log-files are identified, the post-labelling may take place in order to also label the log-files that have not been labeled yet. Thus, a subsequent semi-automated labelling may take place by means of a user/semi-supervised agent that may consider the identified group of log-files.

Due to a variety of reasons, the several log-files stored in the data storage may have a small or not complete number of labeled log-files. However, a complete or high percentage number of labeled log-files in the underlying data storage contributes to a high-quality engine. For this reason, automatic labeling of unlabeled log-files may take place based on given labeled log-files. The automatic labeling may be based on the compressed representation(s) of the log-files, e.g. the vector representation(s).

Another aspect provides that the data storage may comprise a remote data storage module. The remote data storage module may be accessed via the internet such that a large data source can be accessed appropriately. For instance, the data storage comprises a data storage module of a manufacturer and/or a data storage module of a customer. Thus, a hybrid data storage may be established that is based on different data sources, namely a data source of the manufacturer and a data source of the customer.

Generally, the several log-files may be obtained from measurements performed with different measurement setups. The log-files may relate to software and/or hardware measurements from different measurement setups, wherein tests have been performed accordingly. The respective tests performed may encompass passed and failed tests. The respective information concerning the tests may be encompassed in the respective log-files.

Further, embodiments of the present disclosure relate to a method of grouping several log-files. The method comprises the steps of.
Obtaining several log-files,
Deriving a compressed representation for each of the several log-files,
Identifying an underlying pattern within the compressed representations derived from the several log-files, and
Grouping the several log-files based on the underlying pattern identified for each of the compressed representations derived from the several log-files, thereby creating different log-filed groups used for assessing a log-file to be assessed.

The respective method of grouping the several log-files can be used when performing the method of assessing a log-file, as the groups of log-files are created that are compared with the log-file to be assessed in order to identify a subgroup of the several log-files stored in the data storage which are most similar with respect to the log-file to be assessed. The respective similarity identification is based on the compressed representation.

The several log-files may be obtained from different measurements that are performed on at least one device under test, particularly with different measurement setups.

In addition, embodiments of the present disclosure relate to a system for processing at least one log-file. This system comprises a processing circuit that is configured to perform the method described above. The system may relate to a test and measurement system that comprises an analysis engine, e.g. a toolkit, that is executed on the processing circuit.

The system may comprise a test and measurement device that comprises the processing circuit. Therefore, the toolkit may be implemented on the test and measurement device, wherein the toolkit can be executed on the test and measurement device for assessing the log-file to be assessed and/or for grouping the several log-files.

The system may also comprise a front-end connected with the processing circuit, wherein the front-end is capable of presenting information concerning the identified group of log-files that is returned. Accordingly, the user obtains the information via the front-end of the system. The front-end may be part of the test and measurement device of the system. Generally, the system may comprise several types of user equipment which may be used for performing the tests and measurements.

Furthermore, the data storage may comprise a remote data storage module. The remote data storage module may be accessed via the internet. Moreover, the data storage may comprise a data storage module of a manufacturer and/or a data storage module of a customer.

Based on the analysis results found by the analysis engine in the log-file to be assessed, the system/method is capable of suggesting and redirecting the user to result related supporting entities as well as supporting the user or the suggested support entities with several extracted outcomes.

In fact, the respective outcome is a collection of similar cases found in the data storage of the several log-files as well as a possible cause identification report that allows for identification of result related sub-components and more precise root causes.

In a possible implementation, the analysis engine may be implemented in the test and measurement device of the system, for instance as part of a log-file managing tool used for analyzing a measurement execution program. The respective system comprises the analysis engine that is executed on the processing circuit of the system accordingly.

The measurement execution program collects different measurement results in log protocols of multiple formats, for instance measurement series and or text messages generated by sub-components (hardware/software). These are summarized and collected into one log-file that may be loaded into the analysis engine for further processing, namely the analysis engine executed on the processing circuit of the system, thereby performing the method of assessing a log-file.

The compressed representations, e.g. the (float) vectors, encompass mixed content formats, as measurement series or other kind of log protocols are added into the vectors or rather vector representations, particularly in an encoded manner.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a system according to an embodiment of the present disclosure, which illustrates the used case,

FIG. 2 schematically illustrates an overview of a method of assessing a log-file according to an embodiment of the present disclosure,

FIG. 3 shows a detailed view of a step of the method shown in FIG. 2,

FIG. 4A shows another detailed step performed in the method shown in FIG. 2,

FIG. 4B shows yet another detailed step performed in the method shown in FIG. 2,

FIG. 5 shows an optional detail of the method shown in FIG. 2,

FIG. 6 shows an overview that illustrates how log-files are grouped, and

FIG. 7 shows an overview that illustrates how log-files are processed in order to obtain compressed representations for further processing.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Therein and in the following, the terms “circuit” is understood to describe suitable hardware, suitable software, or a combination of hardware and software that is configured to have a certain functionality. The hardware may, inter alia, comprise a CPU, a GPU, an FPGA, an ASIC, or other types of electronic circuitry.

For the purposes of the present disclosure, the phrase “at least one of A, B, and C”, for example, means (A), (B), (C). (A and B), (A and C). (B and C), or (A, B, and C), including all further possible permutations when more than three elements are listed. In other words, the term “at least one of A and B” generally means “A and/or B”, namely “A” alone, “B” alone or “A and B”.

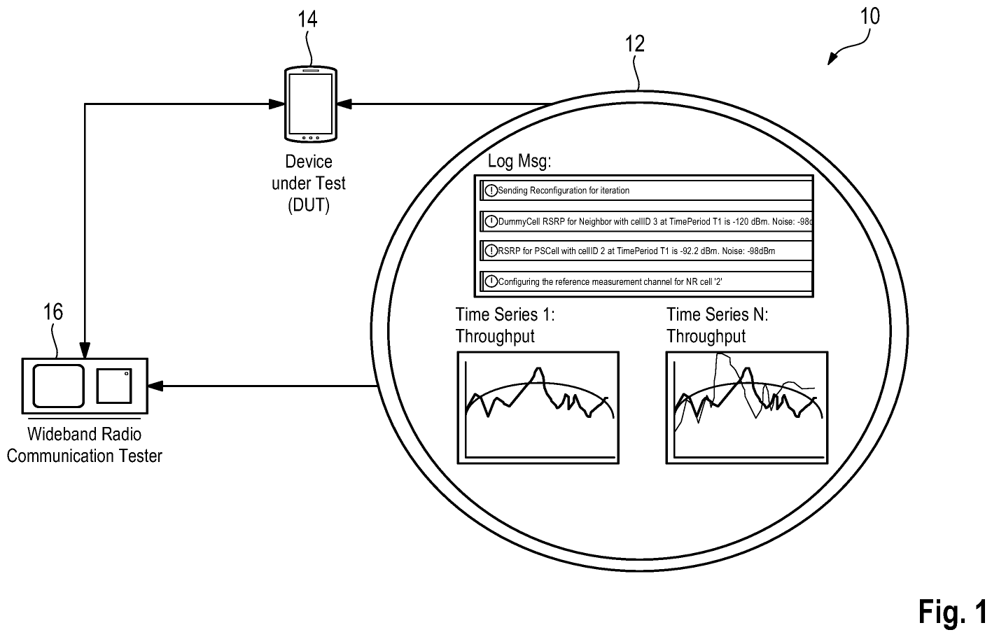

In FIG. 1, a system 10 is shown that is used for processing at least one log-file 12. In fact, the system 10 relates to a test and measurement system and, therefore, the system 10 is also enabled to generate the at least one log-file 12.

The respective log-file is obtained when performing a measurement on a device under test (DUT) 14 that is illustrated as a mobile phone in the shown embodiment. The measurement is done by means of a test and measurement device 16, for instance a wideband radio communication tester as shown in the exemplary embodiment of FIG. 1.

When performing measurements on the device on the test 14, measurement results like throughput are obtained for different time series as illustrated in FIG. 1, namely time series 1 to time series N.

In addition to these measurement results, information and/or data is logged which is written into a log message. These different kinds of information, namely the measurement results and the content of the log message(s), are stored in the log-file 12.

Accordingly, a user may obtain information concerning the measurement setup and/or the behavior of the device under test 14 during the measurement when accessing the log-file 12 due to its content. For instance, the user may obtain information concerning a failed test or an error that occurs during the respective measurement. Hence, the user may access the log-file 12 in order to obtain information that helps to understand the root cause for the failed test or rather the error. However, the log-files 12 typically have a large size and much information contained which cannot be understood by a human without assistance of a computer program that analyzes the content of the log-file.

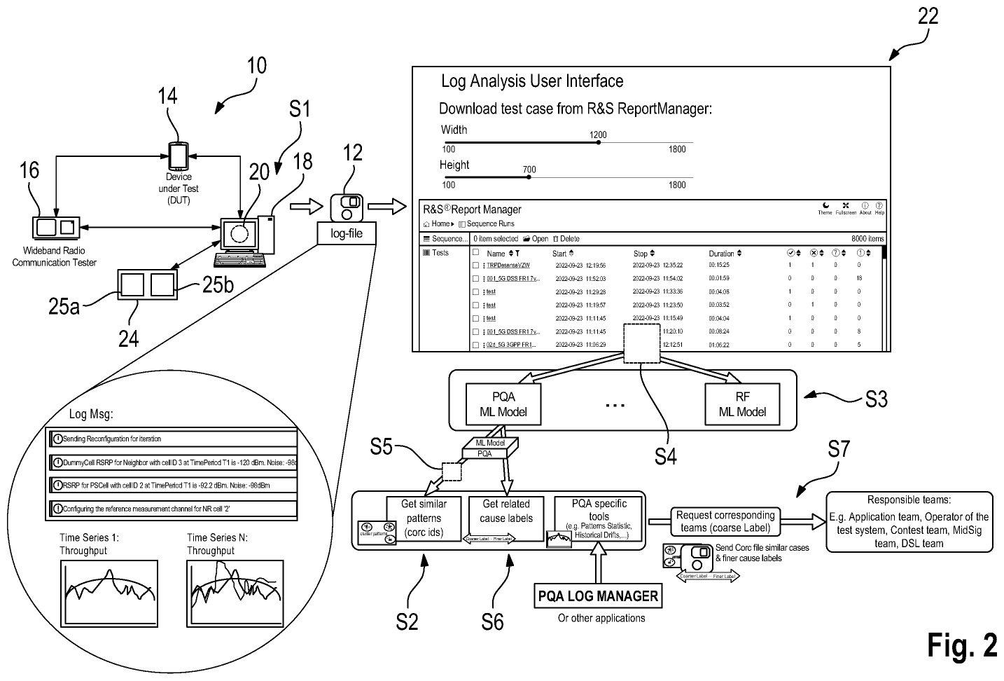

In FIG. 2, an overview of a method for assessing the log-file 12 is shown.

As shown in FIG. 2, the system 10 may comprise a separately formed data processing device 18 that is connected with the test and measurement device 16 and/or the device under test 14 in order to obtain the measurement results and/or the log messages, thereby creating the log-file 12 to be assessed.

The data processing device 18 may comprise a processing circuit 20 that is configured to perform the method described hereinafter in more detail. Alternatively to the shown embodiment, the processing circuit 20 may also be integrated within the test and measurement device 16 such that the test and measurement device 16 itself is capable of performing the method.

In any case, the respective device having the processing circuit 20 may have a front-end 22, also called user interface (UI) as shown in FIG. 2. A user of the system 10 is enabled to retrieve information concerning the log-file 12 via the front-end 22 and/or any outcomes when processing the log-file 12. Accordingly, the front-end 22 is capable of presenting information concerning the log-file 12. For this purpose, the front-end 22 may comprise a display, for instance a touch-sensitive one, thereby providing an input interface as well as an output interface simultaneously.

As shown in FIG. 2, the processing circuit 20, in a first step S1, receives and processes the log-file 12 to be assessed.

FIG. 2 further shows that the system 10 comprises a data storage 24 that comprises several log-files, namely pre-recorded log-files. The processing circuit 20 is generally capable of accessing the data storage 24 in order to get access to the several log-files stored.

The data storage 24 may comprise a remotely accessible data storage module 25a that may be accessed by the internet. Hence, the data storage 24 may relate to a hybrid data storage that comprises the remotely accessible data storage module 25a and a local data storage module 25b. The different data storage modules 25a, 25b may relate to a data storage module of a customer and/or a data storage module of a manufacturer.

The log-files stored in the data storage 24 may be obtained from different measurements that have been performed with different measurement setups. Accordingly, the log-files stored in the data storage 24 relate to passed and/or failed tests from software and/or hardware measurements that have been performed with the different measurement setups on the at least one device under test 14.

Generally, the processing circuit 20, in a second step S2, accesses the data storage 24 that comprises the several log-files, e.g. the already recorded log-files.

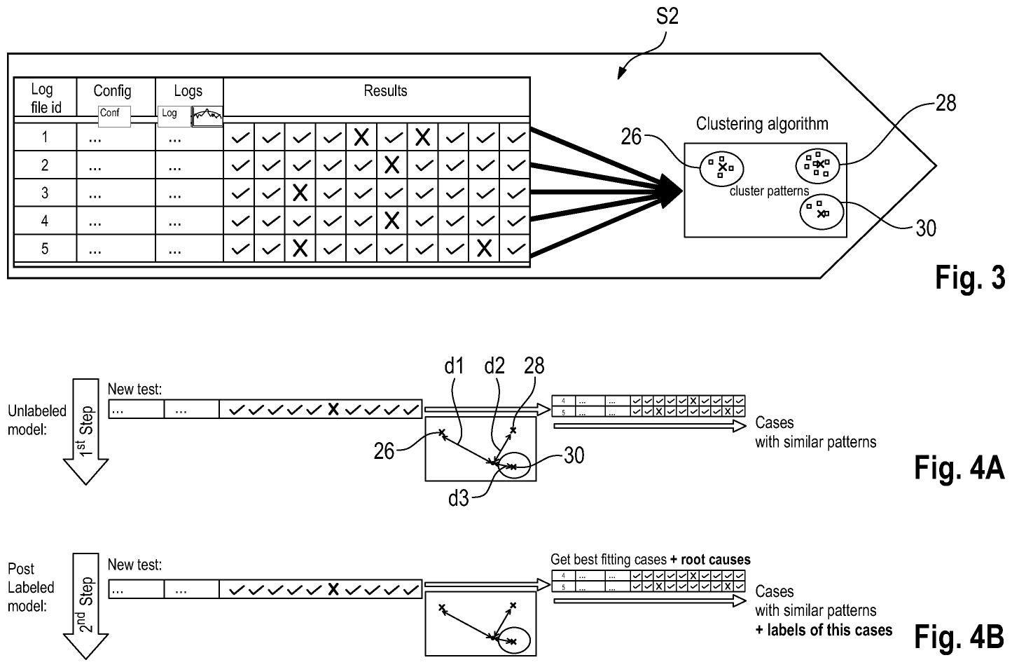

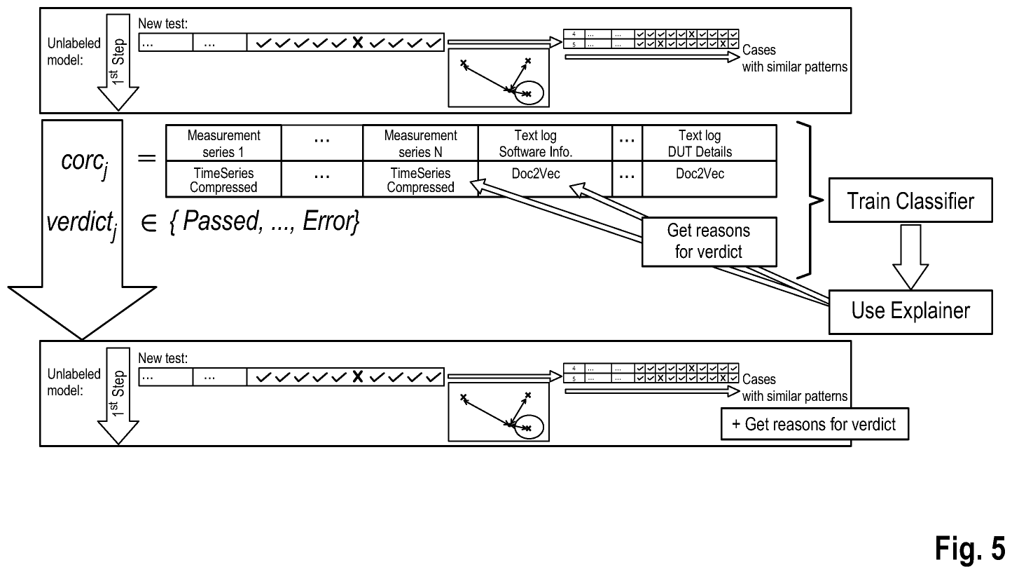

The processing circuit 20 is enabled to identify log-files stored that are similar to the log-file 12 to be assessed, namely the newly generated one. Accordingly, the processing circuit 20 may determine similar log-files with respect to the log-file 12 to be assessed which are stored in the data storage 24. The respective similarities may concern similar patterns, namely underlying patterns, that are determined for the log-files stored in the data storage 24 as well as the log-file 12 to be assessed. This process will be described later in more detail when referring to FIGS. 3 and 4A.

In a previous and optional step S3, the processing circuit 20 may determine a certain category for identifying the pattern within the log-file 12 to be assessed, for instance a Performance and Quality Analysis (PQA) machine-learning (ML) module, a Radio Frequency (RF) machine-learning (ML) module or other modules to be applied in order to identify an underlying pattern within the log-file 12 to be assessed.

For instance, the processing circuit 20 may also determine that no applicable model is provided such that an unknown category is selected. The unknown category may be associated with a manual setup to be implemented by the user via the front-end 22.

Once the respective category has been selected (automatically), e.g. the PQA ML model as shown in FIG. 2, the processing circuit 20 accesses the data storage 24 in order to identify the log-files being nearest to the log-file 12 to be assessed. Accordingly, a certain group of log-files from the several log-files stored in the data storage 24 is identified and returned to the user for further analysis.

In FIG. 3, the identification of the similar already stored log-files is shown in more detail, namely the unlabeled similarity identification, as the log-files stored do not have to be labelled, as the processing circuit 20 determines similarities among the log-files stored and the log-file 12 to be assessed.

Hence, a clustering/grouping algorithm may be applied in step S2 in order to get similar patterns, which is illustrated in FIG. 3. It is shown how the several log-files stored in the data storage 24 are clustered in order to create different log-file groups, also called groups of log-files.

In the shown embodiment, five different log-files are grouped into three different groups of log-files 26, 28, 30, depending on the results contained in the respective log-files. Therefore, the first group 26, the second group 28 as well as the third group 30 generated each have a certain underlying pattern that distinguishes the groups 26-30 from each other as illustrated in FIG. 3.

In FIG. 4A, it is shown how the log-file 12 to be assessed is processed by the method in order to identify the group of log-files that comprise the log-files that are nearest to the log-file 12 to be assessed.

As already mentioned above, an underlying pattern of the log-file 12 to be assessed is determined that is compared to be underlying patterns associated with the different groups 26-30, particularly the respective centers of the clusters/groups 26-30 that are associated with the underlying patterns.

In the shown embodiment, the underlying pattern of the log-file 12 to be assessed is closest/nearest to the underlying pattern of the third group 30, as the respective distance d3 is smaller compared to the distances d1, d2 to the other groups 26, 28, respectively. For instance, an Euclidean distance in the respective pattern room may be taken into account in order to identify the group of log-files that comprise the log-files that are nearest to the log-file 12 to be assessed.

Accordingly, the third group 30 is identified as the group that has the log-files being nearest to the log-file 12 to be assessed such that the third group 30 is returned to the user for further analysis, particularly via the front-end 22, namely the user interface.

As shown in FIG. 4A, the individual log-files of the identified group of log-files, namely the third group 30, are returned to the user. Therefore, the user has access to the respective log-files that are comprised in the identified group 30, as these log-files relate to cases having similar patterns with respect to the pattern pf the log-file 12 to be assessed.

The respective grouping of the several log-files stored in the data storage 24 may be done after the respective category has been determined in step S3. Alternatively, the several log-files may be stored in the data storage 24 in a group-wise manner such that the data storage 24 comprises several different log-filed groups that each comprise a plurality of log-files. In a further alternative, the several log-files may be stored in a group-wise manner, wherein the respective grouping may be reassessed depending on the category selected in step S3. In other words, a default grouping may have taken place.

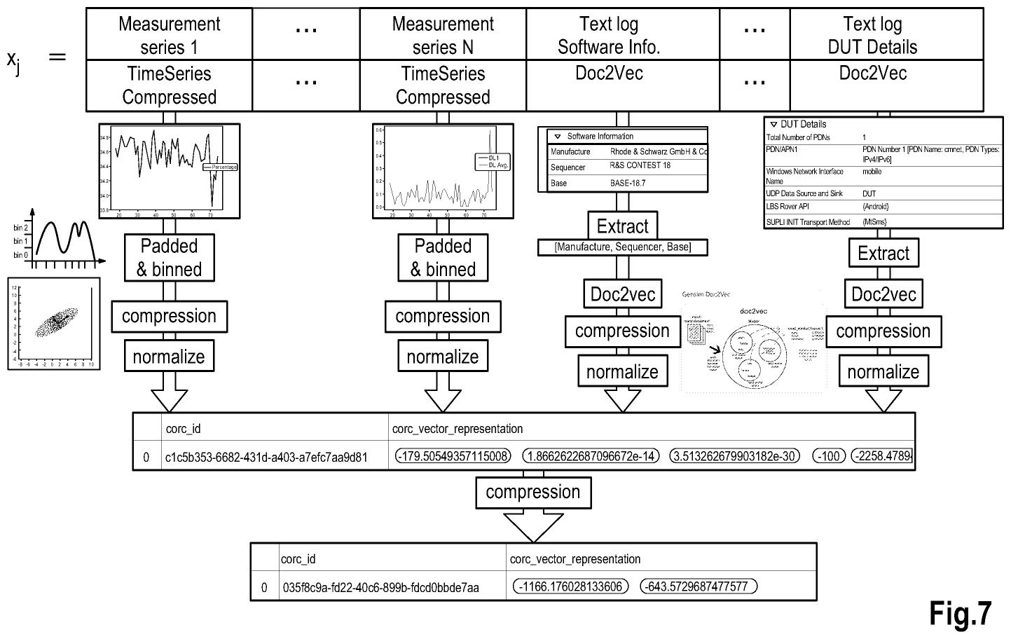

As illustrated in FIGS. 3 and 4A, the underlying patterns are derived from a compressed representation of the respective log-files, wherein the compressed representations may relate to vector representations. FIG. 7 shows how the compressed representations are obtained.

In fact, measurement results obtained for different measurement series, e.g. measurement series 1 to measurement series N, are padded and binned to ensure that they are comparable with regard to their size/time steps (“padding”) and comparable with regard to their y-axis values (“binning”). Afterwards, the respective measurement results can be compressed and normalized.

In addition to these measurement results, the log-files also encompass log messages, namely text logs, for different components, e.g. software and/or the device under test 14. Hence, different formats are handled in order to combine them into the log-file.

From the log-messages information like manufacturer, sequencer and/or base may be extracted and transformed into a vector format. Afterwards, compression and normalization techniques are also applied, thereby ensuring that the different information can be combined into a vector representation that is called “corc_vector_representation” in FIG. 7.

The respective vector representation is compressed afterwards, thereby obtaining the compressed representation based on which the underlying patterns are determined for the log-files as shown in FIGS. 3 and 4A.

Generally, different kinds of compression techniques may be applied, which depends on the kind of data to be compressed. For instance, the padded and binned measurement results can be compressed by different techniques compared with the vectors obtained after transforming the extracted information from the log-messages, as different kind of data formats are compressed, namely numbers and text.

In fact, the log-messages may be processed by means of natural language processing (NLP) based approaches and/or a machine-learning based approaches.

In any case, compressed representations are obtained that are used to determine underlying patterns based on which the grouping/clustering algorithms are applied in order to determine the different groups 26-30 and to identify the respective group 26-30 that comprise the log-files that have similarities with the log-file 12 to be assessed as shown in FIG. 4A.

Generally, the generation of the compressed representations may take place in optional steps S4, S5 as illustrated in FIG. 2.

Accordingly, the log-file 12 to be assessed may be processed in order to obtain the compressed representation based on which an underlying pattern is determined that is used to select (automatically) the respective category/model to applied in step S3. Hence, optional step S4 may take place prior to step S3.

Once the category/model has been selected in step S3, the respective grouping/clustering may take place in step S2. Prior to the grouping/clustering, the compressed representations of the log-files stored in the data storage 24 has to be generated based on which the underlying patterns are determined for identifying the group encompassing the log-files being most similar to the log-file 12 to be assessed. Therefore, optional step S5 takes place prior to step S2, for instance simultaneously with optional step S4.

As shown in FIG. 4B, the respective groups 26-30 may additionally comprise label(s)/tag(s) such that information is additionally returned in an optional step S6, wherein the information is associated with the group identified.

In other words, the respective label(s)/tag(s) associated with the identified group may be output in addition to the identified group itself, particularly the log-files contained in the identified group. Hence, the user obtains additional information, for instance about root causes associated with the identified group as shown in FIG. 4B.

In addition, a semi-automatic labelling process is shown that can be used in order to label the individual log-files. For instance, a classifier can be used to label the respective log-files of a certain group, which has been trained accordingly.

Generally, a semi-automatic labeling may be performed for the entire log-files stored in the data storage, as unlabeled log-files of a certain group are labelled based on existing labels provided of log-files associated with the same group. Rather than labelling the log-files individually, a group-wise labeling may take place such that the respective groups are labeled/tagged rather than their individual log-files.

In FIG. 3, the use of a machine learning based explainer approach is shown for providing additional further information for the user, in which components of a log-file are the main contributor to a certain verdict, namely reasons for a certain verdict like “passed”, “failed” or “error”.

This further information may come together with action recommendations for the user in an optional step S7. For instance, the user may be recommended to replace broken cable and/or to get in contact with a responsible solution team as illustrated in FIG. 2.

Generally, the additional information returned may relate to a leveled approach for label(s)/tag(s).

In fact, a coarse labeling is easier and faster and more robust with respect to upcoming changes. Thus, identified problem components can be redirected faster to a responsible team, whereas less details for an upcoming root cause identification are provided. However, a finer labeling focuses the attention to the possible root causes, but it is less stable with respect to upcoming changes and requires higher efforts. Therefore, a tradeoff with regard to the level of the labeling is necessary.

Furthermore, based on existing log-files in the data storage 24, and their underlying compressed representation(s), an anomaly detection for log-files can be performed with data driven detectors in order to find abnormal log-files.

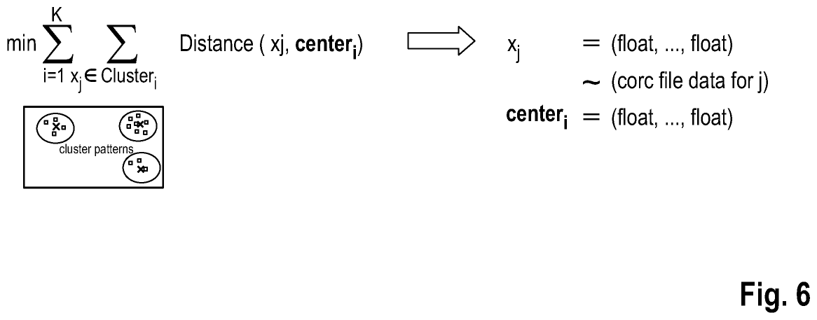

In FIG. 6, an overview of a clustering algorithm applied is shown that illustrates how the several log-files stored in the data storage 24 are clustered in order to obtain the different groups 26 to 30.

As mentioned above, the processing circuit 20 may access the data storage 24 in order to obtain the several log-files stored in the data storage 24. In the steps S4 and S5, compressed representations for each of the several log-files stored in the data storage 24 as well as the log-file 12 to be assessed are derived by techniques illustrated in FIG. 7. In step S2, an underlying pattern within the compressed representations derived from the several log-files is identified, based on which the several log-files are grouped, thereby creating different log-file groups 26-30 used for assessing the log-file to 12 be assessed, as shown in FIGS. 3, 4A and 4B.

Certain embodiments disclosed herein utilize circuitry (e.g., one or more circuits) in order to implement protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A. B, and C,” for example, means (A). (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of assessing a log-file, the method comprising:
receiving a log-file to be assessed,
accessing a data storage that comprises several log-files,
identifying a group of log-files from the several log-files stored in the data storage, wherein the group of log-files comprises log-files that are nearest to the log-file to be assessed, and
returning the identified group of log-files to a user for further analysis.

2. The method according to claim 1, wherein the log-files are returned that are comprised in the identified group of log-files.

3. The method according to claim 1, wherein the several log-files are grouped such that several different log-file groups are obtained that each comprise a plurality of log-files.

4. The method according to claim 1, wherein compressed representations of the several log-files as well as the log-file to be assessed are generated, and wherein the group of log-files is identified based on the compressed representations.

5. The method according to claim 4, wherein the several log-files as well as the log-file to be assessed are compressed by at least one compression method in order to obtain the compressed representations, and wherein the at least one compression method comprises at least one of a natural language processing based approach and/or a machine-learning based approach.

6. The method according to claim 1, wherein the log-files are grouped to log-file groups based on an underlying pattern associated with the log-files.

7. The method according to claim 1, wherein the log-files are grouped to log-file groups based on an underlying pattern associated with the log-files, and wherein the underlying pattern is derived from a compressed representation of the several log-files.

8. The method according to claim 1, wherein the log-files are formatted differently.

9. The method according to claim 1, wherein information is returned that is associated with the group identified.

10. The method according to claim 1, wherein the several log-files are at least partially labeled by labels.

11. The method according to claim 10, wherein the labels relate to analysis information.

12. The method according to claim 1, wherein the several log-files comprise labeled log-files and non-labeled log-files, wherein the non-labeled log-files are processed in order to automatically label the non-labeled log-files based on the labeled log-files.

13. The method according to claim 1, wherein the data storage comprises a remote data storage module.

14. The method according to claim 1, wherein the several log-files are obtained from measurements performed with different measurement setups.

15. A method of grouping several log-files, the method comprising:
obtaining several log-files,
deriving a compressed representation for each of the several log-files,
identifying an underlying pattern within the compressed representations derived from the several log-files, and
grouping the several log-files based on the underlying pattern identified for each of the compressed representations derived from the several log-files, thereby creating different log-file groups used for assessing a log-file to be assessed.

16. A system for processing at least one log-file, wherein the system comprises a processing circuit that is configured to perform the method of claim 1.

17. The system according to claim 16, wherein the system comprises a test and measurement device that comprises the processing circuit.

18. The system according to claim 16, wherein the system comprises a front-end connected with the processing circuit, and wherein the front-end is capable of presenting information concerning the identified group of log-files that is returned.

19. The system according to claim 16, wherein the data storage comprises a remote data storage module.
